(19) United States
(12) Patent Application Publication
(10) Pub. No.: US 2010/0214900 A1
(43) Pub. Date: Aug. 26, 2010

(54) METHOD FOR DELETING DATA OF OPTICAL DISK AND OPTICAL DISK DRIVE INCLUDING OPTICAL DISK EMULATION

(76) Inventors: In Chang Yang, Seoul (KR); Young Mo Goo, Seoul (KR); Byung Ju Dan, Seoul (KR); Byung Hoon Min, Seoul (KR)

Correspondence Address: BIRCH STEWART KOLASCH & BIRCH, PO BOX 747, FALLS CHURCH, VA, 22040-0747, US

(21) Appl. No.: 12/682,749

(22) PCT Filed: Jan. 21, 2008
(86) PCT No.: PCT/KR08/00360

§ 371 Date: Apr. 12, 2010

(30) Foreign Application Priority Data
Nov. 13, 2007 (KR) 10-2007-0115771

(51) Int. Cl. G11B 7/0055

(52) U.S. Cl. 369/83; 369/275.2; G9B/7.019

(57) ABSTRACT

Provided are a method and a device for permanently erasing data of an optical disk in an optical disk drive including an optical disk emulation. According to the method, an erase command of data recorded on an optical disk is received and it is determined whether the optical disk is a rewritable optical disk or not. Then, an output power of a laser to be projected is raised when the optical disk is the rewritable optical disk and then the data recorded on the optical disk are erased through an output power of the laser. Furthermore, the optical disk drive includes an optical disk storage unit, a contents memory unit, a disk type determination unit, a laser power adjustor, a pick-up unit, and a controller.

### TECHNICAL FIELD

The present disclosure relates to a method and a device for permanently erasing data of an optical disk in an optical disk drive including an optical disk emulation.

### BACKGROUND ART

As demands for processing high-quality moving images increase, a high-capacity data storage optical disk is required. Consequently, high-density rewritable optical recording medium that can record and store high quality video and audio data for many hours is brought to the market, recently.

Examples of the high-density rewritable optical recording medium include a blue lay disk (BD), a high definition digital versatile disk (HD-DVD), etc. The DVD has an about 4.7 GB recording capacity and the BD has an about 25 GB recording capacity. After the BD standard has been introduced, the next generation high density/ultra miniature optical storage device has been developed. Examples of the next generation high density/ultra miniature optical storage device include technologies such as super-lens, holography, near field recording, etc.

Recently, because these optical storage devices (e.g., compact disk (CD), DVD, BD, HD-DVD) are widely distributed, a home or office of company keeps several tens to hundreds of optical storage disks containing various contents.

FIG. 1 is a block diagram of a structure of a related art optical disk drive.

The related art optical disk drive includes an optical disk 21, a pick-up unit 11, a servo unit 12, a signal processing unit 14, a memory 15, and a micom 13. The optical disk 21 is a recording medium on which data are recorded, reproduced, and erased by a laser. The pick-up unit 11 records/reproduces management information including data recorded on the optical disk 21. The servo unit 12 controls operations of the pick-up unit 11. The signal processing unit 14 demodulates a reproduction signal received from the pick-up unit 11 into a desired signal value, or modulates a signal to be recorded into a signal having a form necessary for performing a recording operation on the optical disk 21 to transmit the signal. The memory 15 stores various information necessary for reproducing the optical disk 21. The micom 13 controls operations of the above components. The components form a recording/reproducing unit 10.

The pick-up unit 11 includes a laser light source such as a laser diode, a collimator lens, an objective lens driven by a focus actuator or a tracking actuator, a polarized be am splitter, an optical component such as a cylindrical lens, a photodetector converting light into an electrical signal, and a front monitor diode monitoring a laser output during a recording or reproducing operation.

The micom 13 detects reflected light from the optical disk 21, and calculates an amount of the reflected light through the detected reflected light to generate a radio frequency (RF) signal representing a total sum of the reflected light with respect to each area of photodiodes. Additionally, the micom 13 generates a focus error signal (FES), which is a signal detecting an out-of-focus laser illuminated by the pick-up unit 11 through an astigmatism method. Additionally, the micom 13 generates a tracking error signal (TES) detecting an out-of-track laser illuminated by the pick-up unit 11 through a push-pull method.

The memory 15 stores various information necessary for reproducing the optical disk 21 and typically includes a random access memory (RAM) and a read only memory (ROM) to store a control program, a theoretical length of each pit and land, or existence probability in combination of each pit and land.

A controller 23 is responsible for controlling entire components.

A decoder 22 finally decodes output data in response to control of the controller 23 and then provides the decoded data to a user.

To record user desired data on a recording medium, an encoder 24 converts an input signal into a signal of a predetermined format, e.g., a motion picture experts group 2 (MPEG2) transport stream, and then provides the converted signal to the signal processing unit 14 in response to control of the controller 23.

As described above, FIG. 1 illustrates components of recording and reproducing units of the related art optical disk drive. In relation to the reproducing of the optical disk, the optical disk 21, the recording/reproducing unit 10, and the decoder 22 are used. In relation to the recording of the optical disk, the recording/reproducing unit 10, and the decoder 22 are used in response to control of the controller 23.

Since the optical disk drive reproduces/executes only the contents stored on the optical disk 21, there is an inconvenience that the optical disk 21 should be replaced with a new optical disk when a user intends to execute other contents.

Accordingly, there emerges the necessity for an optical disk drive operating as if an optical disk were present even when the optical disk is not inserted, and also the necessity for performing various applications through an optical disk drive through virtualization gradually increases.

For example, when erasing data recorded on an optical disk in the related art optical disk drive, an application for erasing data permanently cannot be provided. Even if recorded data are deleted, there is possibility that erased data can be recovered by recovering a lead-in area and a file system area of the optical disk. Therefore, this limitation causes a very serious limitation to a company that puts a great emphasis on data security.

Furthermore, a method of destroying data includes a method of making scars on the optical disk surface by using a sharp probe and a method of scratching and destructing a dye area on a recording layer. However, pollution problem due to the dyes occurs, and also data recovery is possible because the scratch itself may not completely erase the data on the optical disk.

### DISCLOSURE OF INVENTION

### Technical Problem

Embodiments provide a method of permanently erasing data recorded on a write-once or rewritable optical disk to be irreversible and an optical disk drive using the same.

### Technical Solution

For the above purpose, an erase application performing data erasure is executed in an optical disk drive, and also is performed through an optical disk drive including an optical disk emulation.

Additionally, to achieve the above purpose, adjustment of a laser power and setting of an erase mode are provided to permanently erase data.

In one embodiment, a method of erasing data of an optical disk in an optical disk drive including a data erase application through an optical disk emulation includes: receiving an erase command of data recorded on an optical disk; determining whether the optical disk is a rewritable optical disk or not; raising an output power of a laser to be projected when the optical disk is the rewritable optical disk; and erasing the data recorded on the optical disk through an output power of the laser.

The erasing of the data recorded on the optical disk through the output of the laser may include: performing an overwrite operation on an area of the recorded data through a laser higher than an write power, or destroying boundaries of lands and grooves.

The method may further include performing an overwrite operation on at least a lead-in area and a file system area. The optical disk may include the lead-in area, a user data area, and a lead-out area, the user data area including the file system area where file system data are recorded.

In another embodiment, an optical disk drive includes: an optical disk storage unit recording or reproducing contents through an optical disk; a contents memory unit storing a data erase application therein, and operating as a virtual optical disk when the optical disk is not inserted; a disk type determination unit whether the optical disk is a rewritable or write-once optical disk; a laser power adjustor adjusting an output power of a laser to erase data of the optical disk; a pick-up unit performing an overwrite operation on the optical disk or destroying boundaries of lands and grooves; and a controller allowing the contents memory unit as a virtual optical disk, receiving an erase command of data recorded on the optical disk to load the data erase application, and controlling data erasure of the optical disk.

The contents memory unit may include a data format identical to that of the optical disk. The laser power adjustor may adjust an output power of a laser to more than a write power when the optical disk is a rewritable optical disk, and may adjust the output power of the laser to a write power or an erase power when the optical disk is a write-once optical disk.

The details of one or more embodiments are set forth in the accompanying drawings and the description below. Other features will be apparent from the description and drawings, and from the claims.

### Advantageous Effects

A method of erasing data of an optical disk and an optical disk drive using the same erase data stored on rewritable and write-once optical disks to be irreversible, such that security solution for the erased data can be provided.

### BRIEF DESCRIPTION OF THE DRAWINGS

FIG. 1 is a block diagram of a related art optical disk drive.

FIG. 2 is a block diagram of a structure of an optical disk drive according to one embodiment.

FIG. 3 is a flowchart illustrating processes until an erase application starts according to one embodiment.

FIG. 4 is a flowchart illustrating erasing processes after an erase application starts according to one embodiment.

FIG. 5 is a schematic view of a method of erasing data through weakening of a wobble signal.

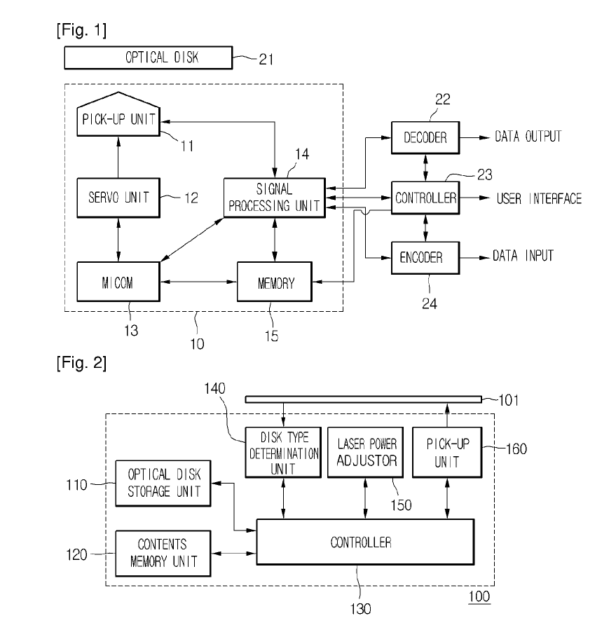

### BEST MODE FOR CARRYING OUT THE INVENTION

Reference will now be made in detail to the embodiments of the present disclosure, examples of which are illustrated in the accompanying drawings.

Terms used in embodiments are general terms that are widely used if possible. However, when an applicant may declare arbitrarily selected terms in a specific case, detailed meaning of the selected term is stated in a corresponding detailed description. Thus, this disclosure must be understood through the meaning of the term not the term itself.

FIG. 2 is a block diagram of a structure of an optical disk drive 100 according to one embodiment.

An optical disk drive 100 with an optical disk includes an optical disk storage unit 110, a contents memory unit 120, a disk type determination unit 140, a laser power adjustor 150, a pick-up unit 160, and a controller 130. The optical disk storage unit 110 stores or reproduces contents through the optical disk. The contents memory unit 120 stores a data erase application therein and is executed as a virtual optical disk when there is no optical disk. The disk type determination unit 140 determines whether the optical disk is a rewritable or write-once optical disk. The laser power adjustor 150 adjusts an output power of a laser to erase data of the optical disk. The pick-up unit 160 overwrites data on the optical disk or destroys the boundaries of lands and grooves. The controller 130 allows the contents memory unit 120 to operate as a virtual optical disk, receives an erase command for erasing data recorded on the optical disk, loads the data erase application, and erases data of the optical disk.

The controller 130 controls the optical disk storage unit 110 and the contents memory unit 120. Additionally, the controller 130 executes an optical disk process command of a host and returns it to the host, and also controls the contents memory unit 120 to operate as a virtual optical disk.

As described below, the controller 130 copies a file system of the optical disk and applies it to the contents memory unit 120, and also controls the contents memory unit 120 through the optical disk process command. Therefore, the contents memory unit 120 can be emulated as the virtual optical disk.

Furthermore, the optical disk drive 100 may further include an optical disk determination unit (not shown) determining whether an optical disk is inserted or not when there is an optical disk process command of a host.

The contents memory unit 120 may include an additional memory such as a random access memory (RAM), a read only memory (ROM), or a free space of an internal memory in an optical disk drive. The contents memory unit 120 stores various applications such as an erase application.

The erase application is a collection of programs for destroying or erasing data recorded on the optical disk and includes an erase engine capable of interpreting, controlling, and determining an optical disk.

A user can access the optical disk drive 100 through a PC interface, and is configured to use the optical disk drive 100 through an interface connection unit.

The controller 130 controls the optical disk storage unit 110 and the contents memory unit 120 when receiving a command of a host.

In more detail, when receiving an optical disk process command from a host, the controller 130 determines whether an optical disk is inserted into the optical disk drive 100 or not according to the optical disk determination unit.

There are various methods of determining whether the optical disk is inserted or not. For example, there are a method of determining an optical disk by detecting an existing reflected light after projecting a laser and a method of determining an optical disk by measuring a change of rotation momentum after rotating the optical disk.

If it is determined that there is no optical disk in the optical disk drive 100 through the optical disk determination unit, the controller 130 controls the contents memory unit 120 to allow the contents memory unit 120 to operate as a virtual optical disk in response to a command from the host, and then returns the result to the host.

To realize the contents memory unit 120 as a virtual optical disk, i.e., an emulation process, is that the contents memory unit 120 may operate pretending as an optical disk by adding properties of the optical disk to the contents memory unit 120 even if there is no optical disk in the optical disk drive 100.

To perform the emulation, a file system managing an optical disk file needs to identically applied to the contents memory unit 120, and also commands processing the optical disk need to be identically applied to the contents memory unit 120.

There are properties to be checked to emulate the contents memory unit 120 as a virtual optical disk. For example, a disk property (whether the optical disk is a ROM type or R/RW type), disk size, disk detail specifications (a track and session information), read/write information, etc. need to be checked.

Additionally, the file system of the optical disk includes ISO09660, a universal disk format (UDF), and UDF-bridge, etc. The file system can be divided into a file system area and a file data area. The file system area includes a disk model name, disk size, and a pointer pointing position of data. As described above, when the emulation of the contents memory unit 120 is performed, the predetermined disk mode name is displayed to a user through a task manager.

Moreover, to emulate the contents memory unit 120 as an optical disk, optical disk process commands need to be identically applied to the contents memory unit 120, and the optical disk process commands may include an advanced technology attachment packet interface (ATAPI).

The ATAPI allows the contents memory unit 120 to be emulated as a virtual optical disk through a “Get Configuration” command, a “Test Unit Ready” command, or a “Read Capacity” command.

The above commands are just examples for this disclosure, and this disclosure is not limited to the above commands.

Furthermore, applying a file system to the contents memory unit 120 can be done by copying information of the file system of the optical disk as it is and applying it, or compressing information of the file system of the optical disk and applying it. A method of compressing information may vary. For example, the file system can be copied using a small amount of a memory by not extracting blocks filled with ‘0’ in a file system area.

Additionally, according to the embodiment, the blocks filed with ‘0’ are not extracted and position information is updated through an address shift in order to compress the file system. As a result, a shift distance is reduced during address mapping, such that management can be easily performed.

When the contents memory unit 120 is emulated through the above processes, the erase application of the optical disk data stored in the contents memory unit 120 is executed.

According to this disclosure, because the erase engine executing the erase application is included in the optical disk drive 100 not the host, the erase application is loaded into the PC when the erase application is executed, and the host calls the erase engine and receives a notice of whether to erase or not.

Accordingly, because the erase engine is included in the host PC, problems that another application interrupts an operation when one application is running can be resolved.

Referring to FIG. 2, once an erase command is received, the disk type determination unit 140 determines whether a type of a disk to be erased is rewritable or not. A method of determining a type of a disk is various. For example, a type of an optical disk can be determined using a physical property in which respectively different types of optical disks has a different reflectivity.

When the disk type determination unit 140 determines the optical disk 101 as a rewritable optical disk, the laser power adjustor 150 raises an output power of a laser to be projected, which is higher than a write power.

The pick-up unit 160 performs an overwrite operation on a recording layer of the optical disk 101 or destroys boundaries between lands and grooves through a laser power higher than the write power.

Additionally, when the disk type determination unit 140 determines the optical disk 101 as a write-once optical disk, the laser power adjustor 150 adjusts an output of the projected laser to the write power or the erase power.

The pick-up unit 160 performs an overwrite operation on a recording layer of the optical disk 101 or destroys boundaries between lands and grooves of the optical disk 101 through a laser power equal to the write power or the erase power.

Additionally, when erasing data on the optical disk 101, an erase mode can be additionally set. The erase mode includes a quick mode destroying an important area of the optical disk and a full mode destroying the entire area of the optical disk.

More specifically, the quick mode minimally destroys the important area of the optical disk such that a user cannot recover the optical disk. Generally, a lead-in area and a file system area constituting the recording layer of the optical disk are destroyed.

Moreover, a process for confirming whether the data is properly destroyed or not may be further included, and this can be done by a fact that an optical pick-up is not properly performed along a track of the optical disk after the data is destroyed.

The full mode erases the entire area of the optical disk such that a user and an expert cannot recover the optical disk. Generally, when the data are erased in the full mode, the entire recording layer, i.e., the lead-in area, the file system area, a lead-out area, and an entire data area are destroyed. In the full mode, destruction can be confirmed on all the destroyed area.

Additionally, the optical disk drive 100 further includes an additional button part, and a user can select data destruction finally. Accordingly, when a data erase operation is set to begin when the user gives a command to erase the optical disk through the button part, reliability for an erase operation can be improved.

Additionally, a confirm window can be displayed to finally confirm whether the disk erase operation starts or not.

Furthermore, while a standby state in the button part continues for a predetermined time, an error of an erase command occurs. Therefore, the optical disk erase process can be terminated.

The performing of the erase application through a vertical optical disk can be done regardless of operating system (OS), and a virtual disk in a drive can be read for an erase operation in any devices.

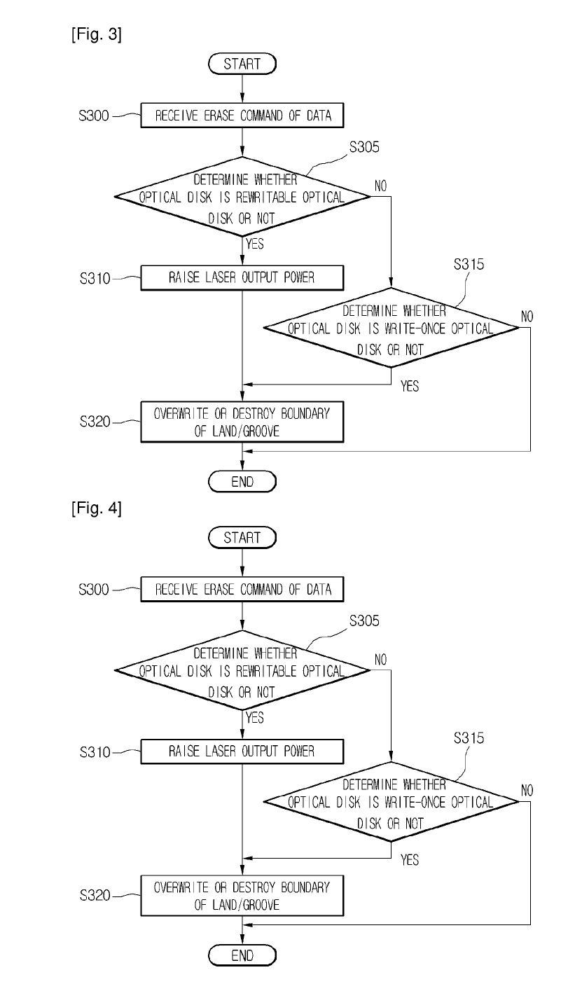

FIG. 3 is a flowchart illustrating processes until an erase application starts according to one embodiment.

That is, a method of erasing data according to an embodiment includes permanently erasing data through an erase application using a virtual disk. The method is performed by using an erase engine in an optical disk drive.

When there is a process command of an optical disk in operation S200, an optical disk determination unit determines whether an optical disk is inserted into an optical disk drive or not in operation S205. When the optical disk is not inserted according to the determination result, a virtualization (emulation) process begins according to an embodiment.

The controller emulates the contents memory unit in operation S210, and selects an erase application stored in the contents memory unit for execution in operation S215 or the erase application is automatically executed. At this point, when the erase application is executed, it automatically recognizes a disk to be erased to select its own optical disk drive for an erase operation.

The erase application is loaded into a host PC in operation S220, and the host PC opens a tray of the optical disk drive in order to insert a disk of which data will be erased.

When the data to be destroyed of the disk is inserted and the tray is closed in operation S230, a data erase process begins in operation S235.

As mentioned above, when the optical disk determination unit determines that the optical disk is inserted in the optical disk drive, the interested optical disk is displayed in operation S240.

FIG. 4 is a flowchart illustrating erasing processes after an erase application starts according to one embodiment.

When an erase command of data is received in operation S300, the disk type determination unit determines whether an optical disk inserted by a user is rewritable or not. As described above, a type of an optical disk can be determined using a physical property in which respectively different types of optical disks has a different reflectivity.

When the inserted optical disk is a rewritable optical disk, an output power of a laser is increased in operation S310. More specifically, the laser power adjustor raises a laser power more than a write power.

When the disk type determination unit determines the optical disk is not rewritable, it is determined whether the optical disk is a write-once optical disk or not in operation S315. When the optical disk is a write-once optical disk, the laser power adjustor adjusts the laser power to the write power or the erase power.

After the size of a laser to be projected is adjusted according to a type of each disk, an overwrite operation is performed on data to be erased or to destroy boundaries of lands and grooves in operation S320.

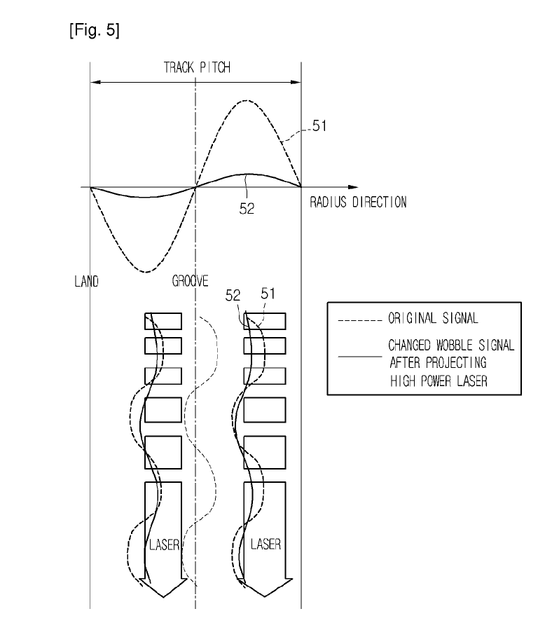

FIG. 5 is a schematic view of a method of erasing data through weakening of a wobble signal.

As illustrated in FIG. 5, when a high power laser is projected on the boundaries of lands and grooves, it can be confirmed that a wobble signal 52 is much weaker than an original signal 51.

When weakening the wobble signal to less than an appropriate level, the optical disk cannot be read any more. Therefore, the optical disk is completely destroyed. That is, a laser tracks the optical disk in response to a wobble signal or an interval of wobble signals and also melts the boundaries of lands and grooves through a high power laser. As a result, an adjacent signal is deteriorated to make data recovery impossible.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method of erasing data of an optical disk in an optical disk drive including a data erase application through an optical disk emulation, the method comprising:
receiving an erase command of data recorded on an optical disk;
determining whether the optical disk is a rewritable optical disk or not;
raising an output power of a laser to be projected when the optical disk is the rewritable optical disk; and
erasing the data recorded on the optical disk through an output power of the laser.

2. The method according to claim 1, wherein the erasing of the data recorded on the optical disk through the output of the laser comprises performing an overwrite operation on an area of the recorded data through a laser higher than an write power, or destroying boundaries of lands and grooves.

3. The method according to claim 2, further comprising performing an overwrite operation on at least a lead-in area and a file system area,
wherein the optical disk comprises the lead-in area, a user data area, and a lead-out area, the user data area including the file system area where file system data are recorded.

4. The method according to claim 1, further comprising determining whether the optical disk is a write-once optical disk or not when the optical disk is not the rewritable optical disk.

5. The method according to claim 4, further comprising performing an overwrite operation on an area of the recorded data through a write power or an erase power when the optical disk is the write-once optical disk.

6. The method according to claim 3, further comprising setting an erase mode of the optical disk.

7. The method according to claim 6, wherein the erase mode comprises a quick mode destroying an important area of the optical disk and a full mode destroying an entire optical disk.

8. An optical disk drive comprising:
an optical disk storage unit recording or reproducing contents through an optical disk;
a contents memory unit storing a data erase application therein, and operating as a virtual optical disk when the optical disk is not inserted;
a disk type determination unit whether the optical disk is a rewritable or write-once optical disk;
a laser power adjustor adjusting an output power of a laser to erase data of the optical disk;
a pick-up unit performing an overwrite operation on the optical disk or destroying boundaries of lands and grooves; and
a controller allowing the contents memory unit as a virtual optical disk, receiving an erase command of data recorded on the optical disk to load the data erase application, and controlling data erasure of the optical disk.

9. The optical disk drive according to claim 8, wherein the contents memory unit comprises a data format identical to that of the optical disk.

10. The optical disk drive according to claim 8, wherein the laser power adjustor adjusts an output power of a laser to more than a write power when the optical disk is a rewritable optical disk, and adjusts the output power of the laser to a write power or an erase power when the optical disk is a write-once optical disk.

11. The optical disk drive according to claim 8, wherein the pick-up unit performs an overwrite operation on a lead-in area and a file system area, and the optical disk comprises the lead-in area, a user data area, and a lead-out area, the user data area including the file system area where file system data are recorded.
